(19) United States
(12) Patent Application Publication
(10) Pub. No.: US 2011/0315367 A1
(43) Pub. Date: Dec. 29, 2011

(54) FLUID COOLED ASSEMBLY AND METHOD OF MAKING THE SAME

(76) Inventors: Guillermo L. Romero, Phoenix, AZ (US); Joe L. Martinez, JR., Scottsdale, AZ (US)

(21) Appl. No.: 12/823,990

(22) Filed: Jun. 25, 2010

(51) Int. Cl. F28F 7/00; B23K 31/02; B23K 20/12

(52) U.S. Cl. 165/185; 228/112.1; 228/114

(57) ABSTRACT

A method of making a fluid cooled assembly that incorporates a base that forms a partial enclosure defining an interior void space and having a top wall that has a top surface and that defines at least one opening through the top wall to the void space, the base further defining fluid entrance and exit ports into the void space, the top wall being made of material that can be friction stir welded. A lid having a size and shape substantially conformal to the opening, having a top surface and a bottom surface that defines a set of downwardly extending pins, and that is formed of a material that can be friction stir welded to the base is placed into the opening so that the lid top surface is flush with the top surface of the base top wall and friction welding the lid to the base.

### BACKGROUND

Liquid cooling of power electronics is an evolving science. One sort of cooling device used today is formed by casting or machining, by an end mill, an open metal box having protrusions rising from the floor. This box is then closed by welding on a lid, and is turned upside down so that electrical components can be attached to a surface supported by the bottom of what had been the floor. One problem with this technique is that the casting and milling techniques used do not permit the cost effective formation of a dense arrays of thin protrusions, which is most effective at transferring heat into a passing liquid.

In another prior art method, sintered copper is molded into a form having narrow pins extending from a planar portion. This method is limited to the use of copper and appears to have use in a narrow range of thermally demanding applications. Copper is softer and heavier than is ideally desirable, and rather expensive. A method of making a fluid cooled assembly having thin (less than 3 mm) pins of a harder, lighter, stronger and less expensive material is desirable.

In another prior art method, copper tubing is formed in a serpentine pattern and embedded with epoxy in an aluminum base with machined grooves or slots. This method presents lower costs but the end product assembly suffers from mediocre thermal performance and high pressure drop.

In still another prior art method, a base is formed, by machining or casting, having a bottom and side walls forming an open cavity. Inlet and outlet ports are also machined on one or more side walls. A finned structure is made by folding thin sheetmetal. This structure is placed into the open cavity, which is closed with a flat top lid to form an enclosed region. All three components are then fused together through a vacuum brazing process. The method can provide reasonable thermal performance but suffers from a complex and expensive assembly process and also results in high pressure drop. For very large structures, this assembly method is often cost prohibitive, as secondary steps are often required to combat material warpage.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect, the present invention may take the form of a method of making a fluid cooled assembly that incorporates a base that forms a partial enclosure defining an interior void space and having a top wall that has a top surface and that defines at least one opening through the top wall to the void space, the base further defining fluid entrance and exit ports into the void space, the top wall being made of material that can be friction stir welded. At least one lid having a size and shape substantially conformal to the opening, having a top surface and a bottom surface that defines a set of downwardly extending pins, and that is formed of a material that can be friction stir welded to the base is placed into the opening so that the lid top surface is flush with the top surface of the base top wall and friction welding the lid to the base.

In a second separate aspect, the present invention may take the form of a fluid cooled electrical assembly, that includes a metal box, having a bottom wall, side walls and a top wall. A set of straight-edged pins, each smaller than 3 mm across in widest dimension, extend down from the top and electrical components are mounted on top of the top wall.

In a third separate aspect, the present invention may take the form of a fluid cooled electrical assembly, that includes an aluminum alloy metal box, having a bottom wall, side walls and a top wall. A set of pins, each smaller than 3 mm across in widest dimension, extend down from the top wall and are unitary to and made of the same material as the top wall and electrical components are mounted on top of the top wall.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced drawings. It is intended that the embodiments and figures disclosed herein are to be considered illustrative rather than restrictive.

FIG. 1 is a perspective view of a work piece that is incorporated into a liquid cooled electrical apparatus, according to the present invention.

FIG. 2 is a perspective view of a lid that is placed into the work piece of FIG. 1, to to form a liquid cooled electrical apparatus, according to the present invention.

FIG. 3A is a perspective view of a step in the manufacturing process of liquid cooled electrical apparatus of the present invention, showing the lids of FIG. 2 positioned so as to be fit into the openings of the work piece of FIG. 1.

FIG. 3B is a perspective view of a liquid cooled assembly of the present invention after the lids of FIG. 2 have been fit in, but before any electrical components have been added.

FIG. 4 is a side view of a power module being placed on the work piece shown in FIG. 3B, to form a final liquid cooled module.

### DETAILED DESCRIPTION OF THE PREFERRED EMBODIMENTS

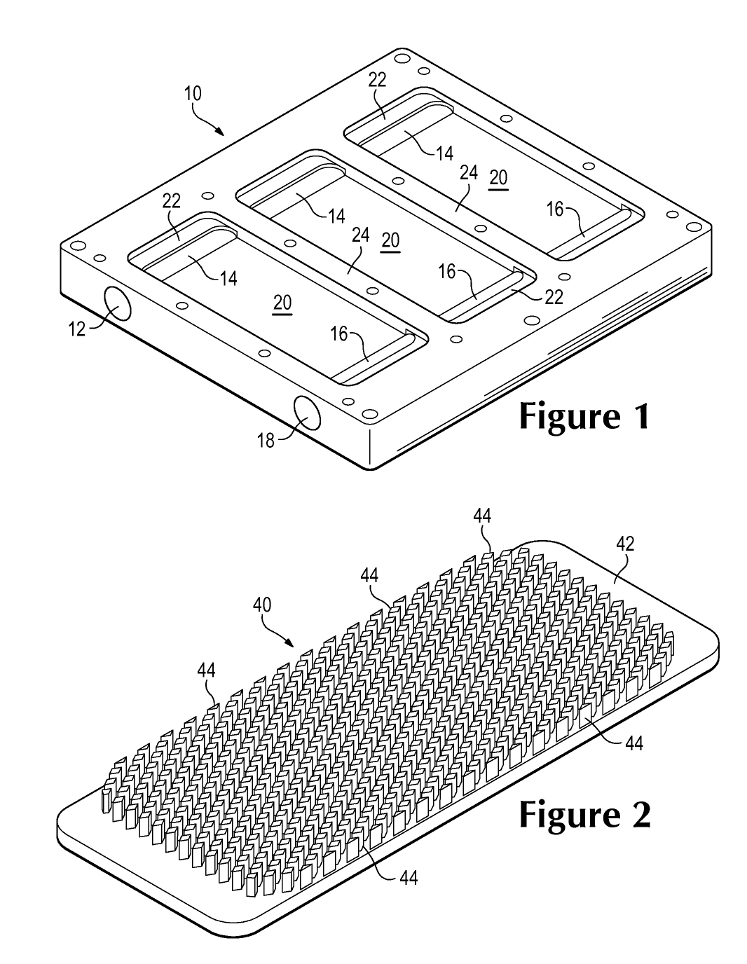

Referring to FIG. 1, in a preferred embodiment the construction of a liquid cooled assembly includes a work piece 10, having an inflow port 12 and inflow channel 14 and an outflow channel 16 and outflow port 18. In the finished assembly, to travel from channel 14 to channel 18, fluid must flow through the three flow cavities 20, either in a series or a parallel fashion, depending on the internal routing features of the work piece. Each cavity has a pair of shelves 22 defined on either side, or a single shelf around the perimeter of the cavity. Cavities are separated by ribs 24.

Referring to FIG. 2, a lid 40 for work piece 10 includes a planar portion 42, which supports a number of downwardly extending pins 44. In one preferred embodiment these pins are formed by sawing into a work piece, which begins as a solid blank of an aluminum alloy. In one embodiment, this sawing is done using ganged saw blades, although it could be done using a single saw blade. In one preferred embodiment pins that are rectangular in cross-section and that have a width of about 0.8 mm to 3 mm are created. In other preferred embodiments, the pins may be square or diamond in cross section. In still another embodiment the lid may be formed with a forging method, whereby the pins can be of any cross section. This method is usually limited to lids measuring no more than 4 inches on any side.

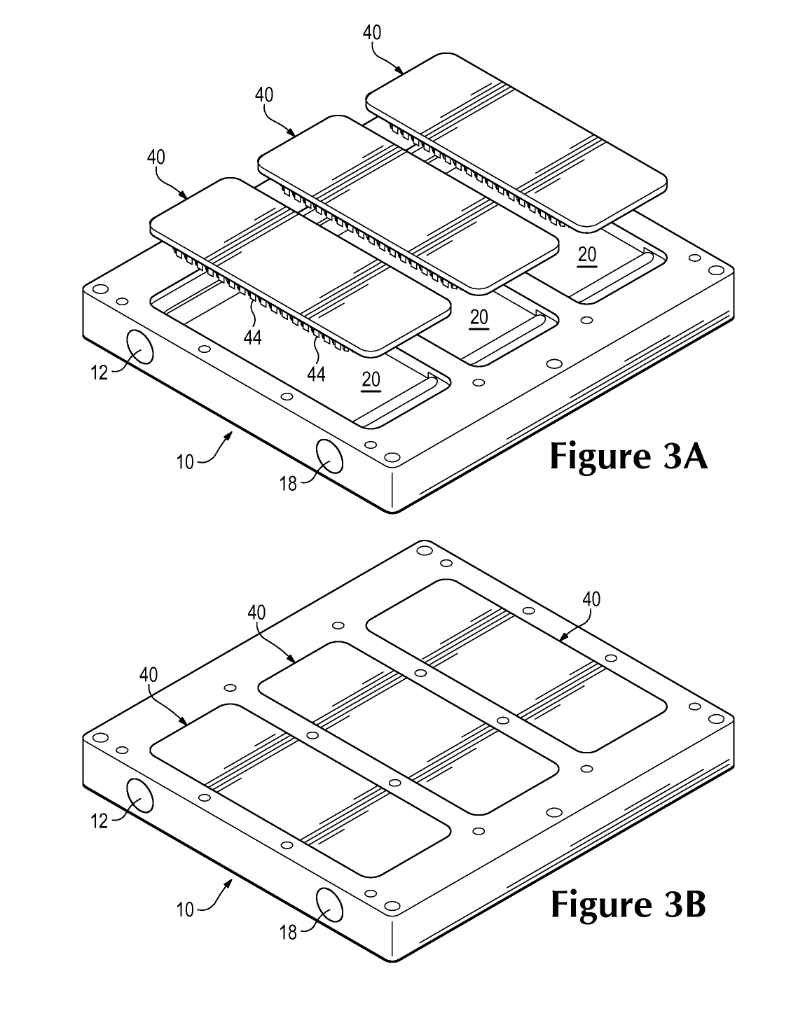

Referring to FIGS. 3A and 3B, lids 40 are placed on shelves 22 and friction stir welded to work piece 10, to cap the flow cavities 20. The top of lids 40 and ribs of work piece 10 form a supporting surface for an electrical assembly needing cooling.

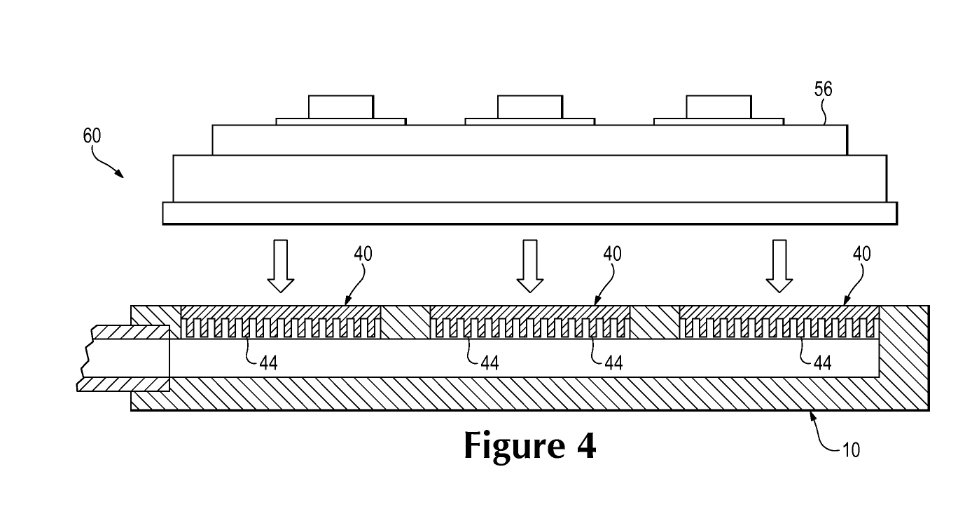

FIG. 4 shows an electrical power module 56 being placed onto work piece 10, to form a final assembly 60.

The result is a robust metal structure having excellent cooling characteristics. Comparable prior art structures were formed by using an end mill to machine pins into the bottom of a work piece similar to 10, and then flipping the assembly upside-down and placing the electrical assembly on this surface. The formation of the pins was hampered by the side walls of the work piece. But in the method of the present invention, the lids 40 do not have comparable side walls, and the metal can be sawn through entirely, from side-to-side, thereby forming a superior array of smaller pins, better suited to carrying heat from the top of each lid 40 into a passing liquid, such as water.

Moreover, the final assembly 50, is made of an aluminum alloy that is hard and strong. In one preferred embodiment aluminum alloy 6061 is used. Other aluminum alloys can also be used. In an alternative preferred embodiment, copper or a copper alloy is used.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method of making a fluid cooled assembly, comprising:
(a) providing a base that forms a partial enclosure defining an interior void space and having a top wall that has a top surface and that defines at least one opening through said top wall to said void space, said base further defining fluid entrance and exit ports into said void space, said top wall being made of material that can be friction stir welded;
(b) providing a lid having a size and shape substantially conformal to said opening, having a top surface and a bottom surface that defines a set of downwardly extending pins, and being formed of a material that can be friction stir welded to said base; and
(c) placing said lid into said opening so that said lid top surface is flush with said top surface of said base top wall and friction welding said lid to said base.

2. The method of claim 1, wherein said opening is defined by edges that taper outwardly from bottom to top and wherein said lid has a matching downwardly facing surfaces so that when said lid is placed on said opening it is supported in position with said top surface of said lid flush to said top surface of said compartment top wall.

3. The method of claim 1, wherein said opening defines ledges positioned to support said lid so that it's top surface is flush to said top surface of said compartment top wall.

4. The method of claim 1, wherein said lid is formed by providing a lid work piece having a bottom surface and sawing into said bottom surface to form said pins.

5. The method of claim 3, wherein said sawing is performed by saw blades that are ganged together.

6. The method of claim 1, further including the step of attaching electric components to said upper surface of said lid.

7. The method of claim 1, wherein said base defines at least one additional opening and wherein at least one further lid is installed.

8. A fluid cooled assembly made by the process of claim 1.

9. A fluid cooled electrical assembly, comprising:
(a) metal box, having a bottom wall, side walls and a top wall;
(b) a set of straight-edged pins, each smaller than 3 mm across in widest dimension, extending down from said top; and
(c) electrical components mounted on top of said top wall.

10. The fluid cooled assembly of claim 9, made of an aluminum alloy.

11. The fluid cooled assembly of claim 9, made of aluminum.

12. The fluid cooled assembly of claim 9, wherein said pins are smaller than 2 mm across in widest dimension.

13. The fluid cooled assembly of claim 9, wherein said pins are smaller than 1.5 mm across in widest dimension.

14. The fluid cooled assembly of claim 9, wherein said pins are smaller than 1 mm across in widest dimension.

15. A fluid cooled electrical assembly, comprising:
(a) an aluminum alloy metal box, having a bottom wall, side walls and a top wall;
(b) a set of pins, each smaller than 3 mm across in widest dimension, extending down from said top wall and being unitary to and made of the same material as said top wall; and
(c) electrical components mounted on top of said top wall.
